(19) United States
(12) Patent Application Publication
(10) Pub. No.: US 2015/0199096 A1
(43) Pub. Date: Jul. 16, 2015

(54) ELECTRONIC DEVICE AND METHOD OF DISPLAYING DATA

(71) Applicant: Samsung Electronics Co., Ltd., Gyeonggi-do (KR)

(72) Inventors: Yu Sic Kim, Gyeonggi-do (KR); Jung Ah Seung, Gyeonggi-do (KR); Hyo Sang Bang, Seoul (KR); Heui Cheon Yang, Seoul (KR)

(21) Appl. No.: 14/559,538

(22) Filed: Dec. 3, 2014

(30) Foreign Application Priority Data
Jan. 10, 2014 (KR) 10-2014-0003454

(51) Int. Cl. G06F 3/0484

(52) U.S. Cl. CPC G06F 3/0484; G06F 2203/04806

(57) ABSTRACT

An electronic device includes: at least one input configured to receive a user input; a controller configured to select a first area including at least one piece of data according to a user manipulation and selecting a second area in which the first area is displayed; and a display configured to expand and then display the first area on the second area, wherein the display reduces and then displays an area other than the first area on areas other than the second area.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 10, 2014 and assigned Serial No. 10-2014-0003454, the entire disclosure of which is hereby incorporated by reference.

### TECHNICAL FIELD

The present disclosure relates to an electronic device displaying data on a display screen and a method of displaying data.

### BACKGROUND

As the value of information is more important than that of a material goods in the twenty-first century, the twenty-first century is called the information age. In particular, as digital environments have recently expanded, there are increases in the amount of data created and the cycles and formats of data, so that big data that is difficult to collect, store, search and analyze is becoming a social issue.

Thus, the processes of processing and analyzing data and creating meaningful data are becoming important. In addition, a method of more efficiently providing analyzed data to a user is also becoming important.

There are various methods of transmitting analyzed data to a user and in particular, as various electronic devices are being developed due to the advancement of an electronic technology, cases in which various types of data are provided through electronic devices are increasing.

### SUMMARY

When providing data to a user through an electronic device as described above, there may be cases where there is a need to expand a portion of desired data due to constraints on the size and performance of a display screen. However, when data is expanded and provided, other data disappears from the display screen and an additional input is needed to allow a user to check this other data.

To address the above-discussed deficiencies, it is a primary object to provide an electronic device that may expand data without disturbing other data and provide particular information on expanded data, and a method of displaying data.

Also, various embodiments of the disclosure are directed to providing an electronic device that enables a user to select and display data more conveniently and intuitively, and a method of displaying data.

According to an embodiment of the present disclosure, an electronic device includes: at least one input configured to receive a user input; a controller configured to select a first area including at least one piece of data according to a user manipulation and selecting a second area in which the first area is displayed; and a display configured to expand and then display the first area on the second area, wherein the display reduces and then displays an area other than the first area on areas other than the second area.

The display may display at least one object when a user manipulation for selecting the first area is input, and the controller may select an area specified by the object as the first area.

When the first area is selected and then the object moves according to a user manipulation, the controller may select an area specified by a moved object as the second area.

When the object moves according to a user manipulation while the first area is expanded and then displayed, the controller may use the moved object to change the first area and the second area.

The display may display at least one of the hue, brightness and saturation of the second area differently from that of areas other than the second area.

The display may display at least one of the average value, maximum value, minimum value, and median of data, and the difference value between the maximum value and the minimum value on the second area, wherein the data may be included in the first area.

The display may display the data values of data included in the first area in the second area.

When data included in the first area includes detailed data corresponding to a lower category, the display may display the detailed data on the second area.

According to an embodiment of the present disclosure, a method of displaying data includes: selecting a first area including at least one piece of data according to a user manipulation; selecting a second area in which the first area is displayed, according to a user manipulation; and expanding and then displaying the first area on the second area and reducing and then displaying areas other than the first area on areas other than the second area.

The selecting-a-first-area may include: displaying at least one object on the display screen according to a user manipulation; and selecting, an area specified by the object, as the first area.

The selecting-a-second-area may include: moving the object according to a user manipulation; and selecting an area specified by a moved object as the first area.

The method may further include: moving the object according to a user manipulation while the first area is expanded and then displayed; and expanding and then displaying an added first area on an area specified by the movement of the object when a first area is added by the movement of the object.

The method may further include: moving the object according to a user manipulation while the first area is expanded and then displayed; and reducing and then displaying an excluded first area on areas other than the area specified by the movement of the object when at least a portion of the first area is excluded by the movement of the object.

The method may further include changing and then displaying data included in the first area to preset data, while the first area is expanded and then displayed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to an embodiment of the present disclosure.

FIGS. 2A and 2D illustrate a process of displaying data according to an embodiment of the present disclosure.

FIGS. 3A and 3B illustrate a method of expanding data according to an embodiment of the present disclosure.

FIGS. 4A to 5C illustrate a process of displaying data according to another embodiment of the present disclosure.

FIGS. 6A to 6F illustrate a process of displaying data according to another embodiment of the present disclosure.

FIGS. 7A to 7C illustrate a process of displaying data according to another embodiment of the present disclosure.

FIGS. 8A to 8D illustrate a process of displaying data according to another embodiment of the present disclosure.

FIGS. 9A to 9C illustrate a process of displaying data according to another embodiment of the present disclosure.

FIGS. 10A to 10D illustrate a process of displaying data according to another embodiment of the present disclosure.

FIGS. 11A to 11D illustrate a process of displaying data according to another embodiment of the present disclosure.

FIGS. 12A to 12D illustrate a process of displaying data according to another embodiment of the present disclosure.

FIGS. 13A to 13E illustrate a process of displaying data according to another embodiment of the present disclosure.

FIGS. 14A to 14B illustrate a process of displaying data according to another embodiment of the present disclosure.

FIGS. 15A to 15D illustrate a process of displaying data according to another embodiment of the present disclosure.

FIGS. 16A to 16D illustrate a process of displaying data according to another embodiment of the present disclosure.

FIG. 17 illustrates a flowchart of a method of displaying data according to an embodiment of the present disclosure.

### DETAILED DESCRIPTION

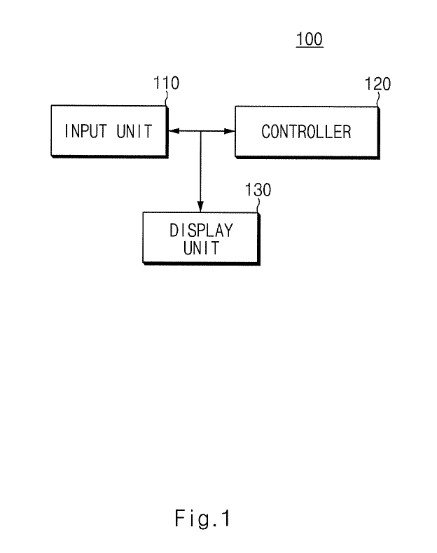

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The present disclosure is described below in detail with reference to the accompanying drawings.

FIG. 1 illustrates a block diagram of an electronic device according to an embodiment of the present disclosure.

Referring to FIG. 1, an electronic device 100 includes an input unit 110, a controller 120, and a display unit 130. The electronic device 100 may be implemented as various types of devices that have a display screen, such as a TV, a mobile phone, a smart phone, a personal digital assistant (PDA), a notebook PC, a desktop PC, and a tablet PC.

The input unit 110 may receive a user manipulation for controlling the electronic device 100. In particular, the input unit 110 may receive a user manipulation for selection a first area that includes at least one piece of data. Also, it is possible to receive a user manipulation for selecting a second area in which a selected first area is displayed.

In addition, while the first area is expanded and displayed in the second area, the input unit 110 may receive a user manipulation for selecting a new first area or for excluding at least a portion of the selected first area.

In addition, while the first area is expanded and displayed in the second area, the input unit 110 may receive a user manipulation for selecting a new second area or for excluding at least a portion of a selected second area.

The input unit 110 may be implemented as at least one of a touch screen or a touch pad operating by a user's touch input, a mouse, and a motion recognition sensor recognizing a user's motion.

In particular, the input unit 110 may be variously implemented according to the type and characteristic of the electronic device 100. For example, when the electronic device 100 is implemented as a smart phone, the input unit 110 may be implemented as a touch screen. When the electronic device 100 is implemented as a TV, the input unit 110 may be implemented as a motion recognition sensor or remote control including a touch pad.

The controller 120 may select a first area including at least one piece of data according to a user manipulation. Also, it is possible to select a second area in which the first area selected according to the user manipulation is displayed.

In addition, while the first area is expanded and displayed, the controller 120 may select a new first area or exclude a selected first area according to a user manipulation. Also, it is possible to change the second area according to a user manipulation while the first area is expanded and displayed. That is, when an object moves according to a user manipulation while the first area is expanded and displayed, the controller 120 may use a moved object to newly select a first area and a second area.

The display unit 130 may expand and then display the first area in the second area, and it may reduce and then display areas other than the first area in areas other than the second area.

In this example, the display unit 130 may display at least one of the hue, brightness and saturation of the second area differently from that of areas other than the second area in order to distinguish the second area from areas other than the second area.

In addition, the display unit 130 may display at least one of the average value, maximum value, minimum value and median of data included in the second area, and the difference value between the maximum value and the minimum value. Also, the display unit 130 may display the data value of data included in the second area.

In addition, the display unit 130 may display detailed data in the second area when the data included in the first area includes detailed data corresponding to a lower category.

In addition, when a first area is added or a pre-selected first area is excluded by the controller 120 while the first area is expanded and displayed, the display unit 130 may expand and then display an added first area or reduce and then display an excluded first area.

The display unit 130 may display at least one object on a display screen when a user manipulation for selecting the first area is input. The object displayed on the display screen may be moved by a user manipulation and when the user manipulation is completed, the controller 120 may select an area specified by the object as the first area. For example, when two objects are displayed on the display screen, the controller 120 may select the area between the two objects as the first area. Then, when a user manipulation for selecting a second area is input, an object may move according to the user manipulation. When the user manipulation is completed, the controller 120 may select an area specified by a moved object as the second area.

That is, a user may use the object displayed on the display screen to select the first area and the second area.

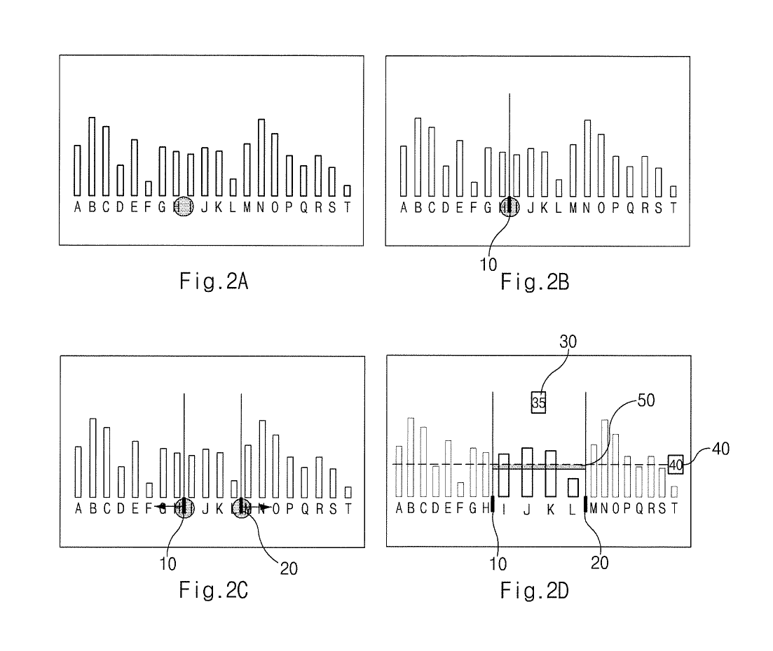

In the following, a particular example of how the electronic device 100 displays data is described with reference to FIGS. 2A to 16D. As described above, although the input unit 110 may be implemented as one of various input devices, a case where the input unit 110 is implemented as a touch screen is described as an example for convenience of description.

FIGS. 2A to 2D illustrate a process of displaying data according to an embodiment of the present disclosure.

Referring to FIG. 2A, data is displayed as bar graphs on a display screen. When a user touches a specific point on the display screen with his or her finger, a first object 10 may be displayed as shown in FIG. 2B. Then, when the user touches another point by dragging a touched finger or with another finger, a second object 20 may be displayed as shown in FIG. 2C. Then, the user may move the objects until the touched finger is removed from the display screen.

As another embodiment, when the user touches the display screen with his or her two fingers together, a first object and a second object may be displayed together on touched points. Then, the user may move the objects until the touched fingers are removed from the display screen.

When the user manipulation is completed, an area specified by the objects may be selected as a first area. Referring to FIG. 2C, the area between the first object 10 and the second object 20 may be selected as the first area.

When the first area is selected, the user may touch and move at least one of the first object 10 and the second object 20 in order to select a second area in which the first area is displayed. When a user manipulation for selecting the second area is completed, an area specified by a moved object may be selected as a second area. Referring to FIG. 2D, the area between the first object 10 and the second object 20 may be selected as the second area.

When the second area is selected, the first area may be expanded and displayed in the second area as shown in FIG. 2D. Also, areas other than the first area may be reduced and displayed in areas other than the second area. In this example, the second area may be clearly displayed and areas other than the second area may be vaguely displayed.

In addition, the average value 30 of data included in the first area may be displayed in the second area. Also, the average value 40 of all data may be displayed on the display screen. The location of the average value 40 of all data may be determined depending on the values of data. In addition, an object (such as a broken line or a solid line) for comparison with other data may be displayed on the location where the average value 40 of all data is displayed.

Also, referring to FIG. 2D, an object 50 representing the difference value between the average value 40 of all data and the average value 30 of data included in the selected first area may be displayed in the second area. In addition, the data value of data included in the selected first area may be displayed in the second area.

The process of expanding and displaying the first area is described with reference to FIGS. 2A-2D, but when the first area is selected and then the first object 10 and the second object 20 move so that they are close to each other, the first area may also be reduced and displayed in a second area specified by moved objects. In this case, areas other than the first area may be expanded and displayed in areas other than the second area.

According to FIGS. 2A-2D, the user may conveniently select the first area and the second area for displaying the selected first area by using objects and obtain various pieces of information related to data included in the selected first area.

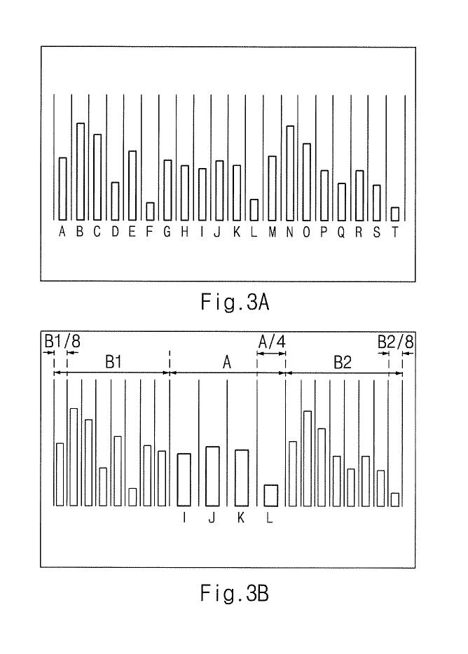

FIGS. 3A and 3B illustrate a method of expanding data according to an embodiment of the present disclosure.

Referring to FIG. 3A, data is displayed as bar graphs on a display screen. When a first area and a second area are selected according to a user manipulation, the width of the second area is equally divided according to the number of pieces of data included in the first area so that data may be displayed in each area. Referring to FIG. 3B, the width A of the second area is divided into four areas so that data may be expanded and then displayed in each area.

Also, areas other than the second area may also be equally divided according to the number of pieces of data included in areas other than the second area so that data may be displayed in each area. Referring to FIG. 3B, the widths B1 and B2 of remaining areas are divided into eight areas respectively so that data may be reduced and displayed in each area.

According to FIGS. 3A and 3B, when expanding or reducing and then displaying data, the first area may be expanded or reduced in the direction in which objects move. That is, when objects move in the x-axis direction as shown in FIGS. 3A and 3B, the first area may be expanded and displayed in the x-axis direction.

Although FIGS. 3A and 3B show that data is displayed as bar graphs for example, the present disclosure may also be applied to data having other forms such as a radar chart, and a line graph. Also, when the selected first area is also reduced and displayed, the present disclosure may be similarly applied.

When the gaps between data included in the first area and areas other than the first area are unequal, each piece of data may be expanded or reduced in proportion to the existing gap between data.

According to another embodiment, the data gap may be expanded according to the width ratio between the first area and the second area. For example, when the width ratio between the first area and the second area is 1:2, it is possible to expand the first area twice and display an expanded area in the second area. Similarly, it is possible to reduce and then display areas other than the first area according to the width ratio between areas other than the first area and areas other than the second area.

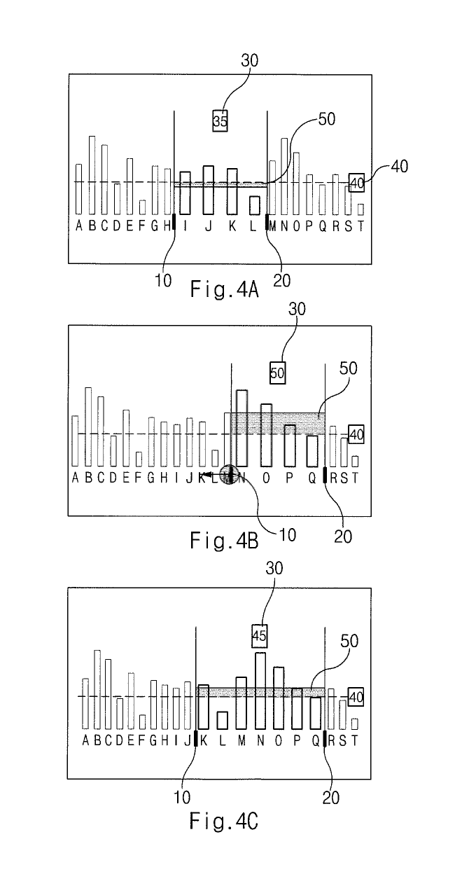

FIGS. 4A to 4C illustrate a process of displaying data according to another embodiment of the present disclosure.

FIG. 4A represents a display screen on which the first area is expanded and displayed in the second area according to the process described with respect to FIGS. 2A-2D. In order to select a new first area while a selected first area is expanded and displayed, it is possible to move the first object 10 and the second object 20. For example, when the point between the first object 10 and the second object 20 is touched and a touched finger is dragged, it is possible to move the first object 10 and the second object 20 together as shown in FIG. 4B.

With the movement of the objects, a new first area and a second new area may be selected. In addition, a new first area may be expanded and displayed in a new second area specified by moved objects as shown in FIG. 4B. A selected new first area may also include some of existing data or only completely new data according to the movement level of objects. The first area excluded by the movement of objects may be reduced and displayed in areas other than the area specified by moved objects.

When the point between the first object 10 and the second object 20 is touched and the objects move, it is possible to change only the sections of data without a change in the number of pieces of data included in the first area as shown in FIG. 4B.

With the change of the first area, the average value 30 of data included in the first area and the object 50 representing the difference value between the average value of all data and the average value 30 of data included in a selected first area may be changed.

In order to add a new first area or exclude a portion of a selected first area while a first area is expanded and displayed, it is possible to move one of the first object 10 and the second object 20. For example, when the first object 10 is touched and a touched finger is dragged to the left of the display screen, it is possible to move the first object 10 as shown in FIG. 4C. Referring to FIG. 4C, with the movement of the first object 10, the second area may be changed and new data may be additionally displayed in a changed second area.

With the change of the first area, the average value 30 of a selected first area and the object 50 representing the difference value between the average value of all data and the average value 30 of data included in the selected first area may be changed.

When moving the first object 10 to the right, a portion of the selected first area may be excluded due to the movement of the object. The data included in the excluded portion of the first area may be reduced and displayed in areas other than the second area specified by a moved object.

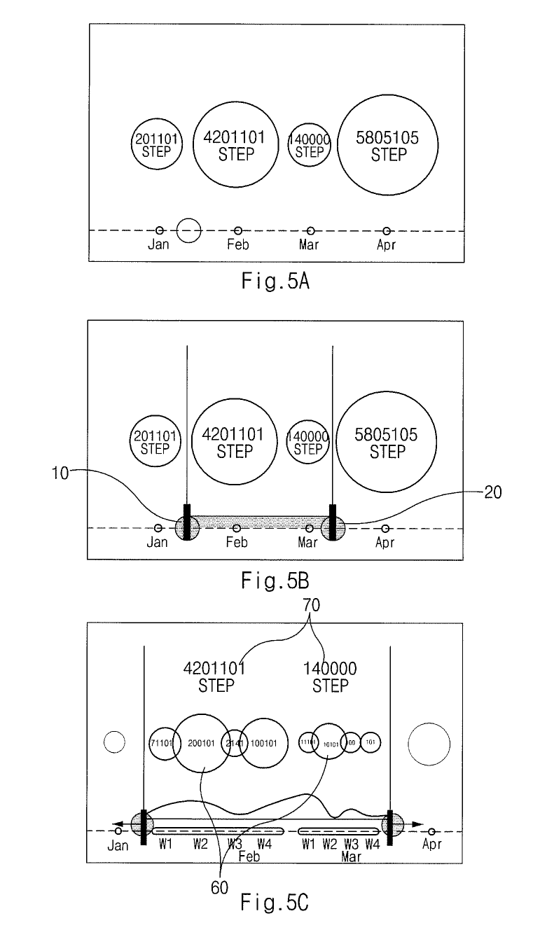

FIGS. 5A to 5C illustrate a process of displaying data according to another embodiment of the present disclosure.

Referring to FIG. 5A, data representing the number of steps per month is displayed as circle graphs on a display screen. The data representing the number of steps per month may include detailed data representing the number of steps per week.

When a user manipulation for selecting a first area including at least one of pieces of data displayed on the display screen is input, the first object 10 and the second object 20 may be displayed as shown in FIG. 5B. Then, an area specified by the objects may be selected as a first area. Referring to FIG. 5B, the area between the first object 10 and the second object 20 may be selected as the first area.

When the first area is selected, the user may touch and move at least one of the first object 10 and the second object 20 in order to select a second area in which the first area is displayed. When a user manipulation for selecting the second area is completed, an area specified by a moved object may be selected as the second area.

In this example, when data included in a selected first area includes detailed data corresponding to a lower category, detailed data corresponding to a lower category may be displayed in the second area.

Referring to FIG. 5C, data on the numbers of steps in February and March may be subdivided into data 60 on the number of steps per week and displayed. Also, the data value 70 of a higher category may be displayed along with detailed data corresponding to a lower category.

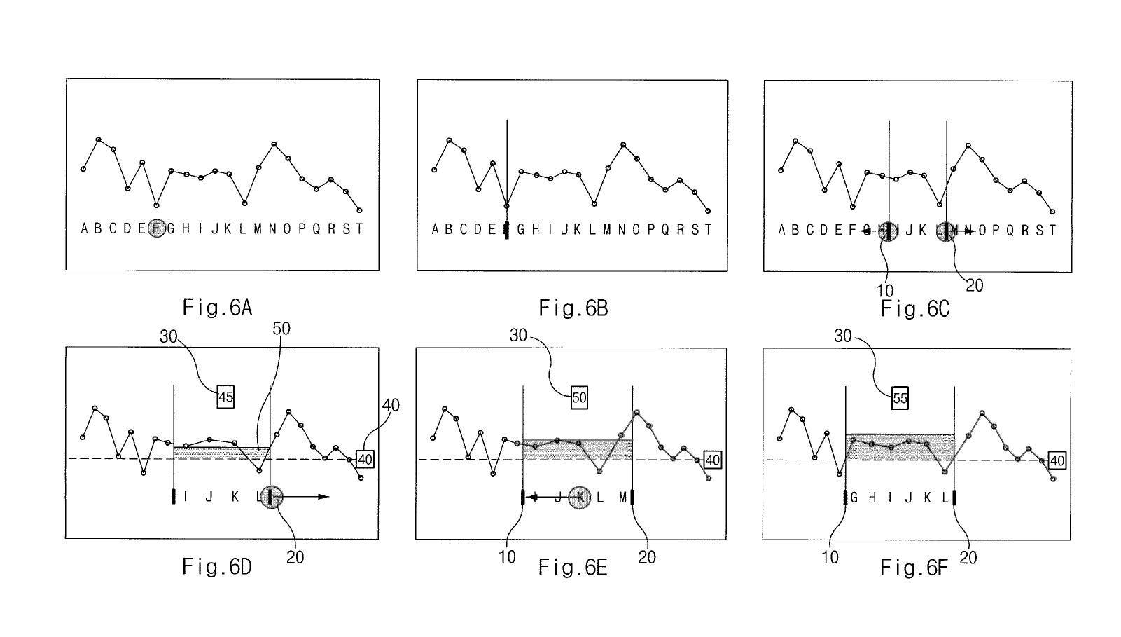

FIGS. 6a to 6f illustrate a process of displaying data according to another embodiment of the present disclosure.

Referring to FIG. 6A, data is displayed as line graphs on a display screen. When a user touches a specific point on the display screen with his or her finger in order to select a first area including at least one of pieces of data displayed on the display screen, the first object 10 may be displayed as shown in FIG. 6B. Then, when the user touches another point by dragging a touched finger or with another finger, the second object 20 may be displayed as shown in FIG. 6C. Then, the user may move the objects until the touched fingers are removed from the display screen.

When a user manipulation for selecting the first area is completed, an area specified by objects may be selected as the first area. Referring to FIG. 6C, the area between the first object 10 and the second object 20 may be selected as the first area.

When the first area is selected, the user may touch and move at least one of the first object 10 and the second object 20 in order to select a second area in which the first area is displayed. When a user manipulation for selecting the second area is completed, an area specified by a moved object may be selected as the second area. Referring to FIG. 6D, the area between the first object 10 and the second object 20 may be selected as the second area.

When the second area is selected, the first area may be expanded and displayed in the second area as shown in FIG. 6D. Also, areas other than the first area may be reduced and displayed in areas other than the second area. In this example, the second area may be clearly displayed and areas other than the second area may be vaguely displayed.

In addition, the average value 30 of data included in the first area may be displayed in the second area. Also, the average value 40 of all data may be displayed on the display screen. The location of the average value 40 of all data may be determined depending on the values of data. In addition, an object (such as a broken line or a solid line) for comparison with other data may be displayed on the location where the average value 40 of all data is displayed.

Also, referring to FIG. 6D, the object 50 representing the difference value between the average value 40 of all data and the average value 30 of data included in the selected first area may be displayed in the second area. In addition, the data value of data included in the selected first area may be displayed in the second area.

In order to add a new first area or exclude a portion of a selected first area while a first area is expanded and displayed, it is possible to move one of the first object 10 and the second object 20. For example, when the first object 20 is touched and a touched finger is dragged to the left of the display screen, it is possible to move the second object 10 as shown in FIG. 6E. Referring to FIG. 6E, with the movement of the second object 20, the second area may be changed and new data may be additionally displayed in a changed second area.

When moving the second object 20 to the left, a portion of the selected first area may be excluded due to the movement of the object. The data included in the excluded portion of the first area may be reduced and displayed in areas other than the second area specified by a moved object.

In order to select a new first area, it is possible to move the first object 10 and the second object 20. For example, when the point between the first object 10 and the second object 20 is touched and a touched finger is dragged, it is possible to move the first object 10 and the second object 20 together as shown in FIG. 6F.

With the movement of the objects, a new first area and a second new area may be selected. In addition, a new first area may be expanded and displayed in a new second area specified by moved objects as shown in FIG. 6F. A selected new first area may also include some of existing data or only completely new data according to the movement level of objects. The first area excluded by the movement of objects may be reduced and displayed in areas other than the area specified by moved objects.

When the point between the first object 10 and the second object 20 is touched and the objects move, it is possible to change only the type of data without a change in the number of pieces of data included in the first area as shown in FIG. 6F.

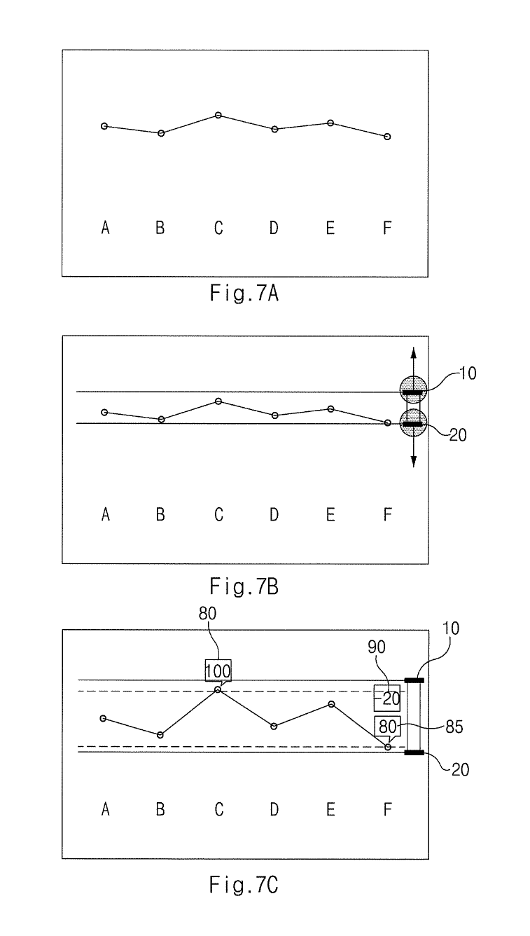

FIGS. 7A to 7C illustrate a process of displaying data according to another embodiment of the present disclosure.

Referring to FIG. 7A, data is displayed as line graphs on a display screen. Pieces of data shown in FIG. 7A have similar data values, so it is not easy to distinguish them from one another. To make the differences between data clear, data may be expanded in the y-axis direction and displayed.

When a user manipulation for selecting a first area including at least one of pieces of data displayed on the display screen is input, the first object 10 and the second object 20 may be displayed as shown in FIG. 7B. When a user manipulation for selecting the first area is completed, an area specified by objects may be selected as the first area. Referring to FIG. 7B, the area between the first object 10 and the second object 20 may be selected as the first area.

When the first area is selected, the user may touch and move at least one of the first object 10 and the second object 20 in order to select a second area in which the first area is displayed. When a user manipulation for selecting the second area is completed, an area specified by a moved object may be selected as the second area. Referring to FIG. 7C, the area between the first object 10 and the second object 20 may be selected as the second area. When the second area is selected, the first area may be expanded and displayed in the second area as shown in FIG. 7C. Also, areas other than the first area may be reduced and displayed in areas other than the second area.

In addition, referring to FIG. 7C, the maximum value 80, minimum value 85 and median of data included in the first area, and the difference value 90 between the maximum value and the minimum value may be displayed.

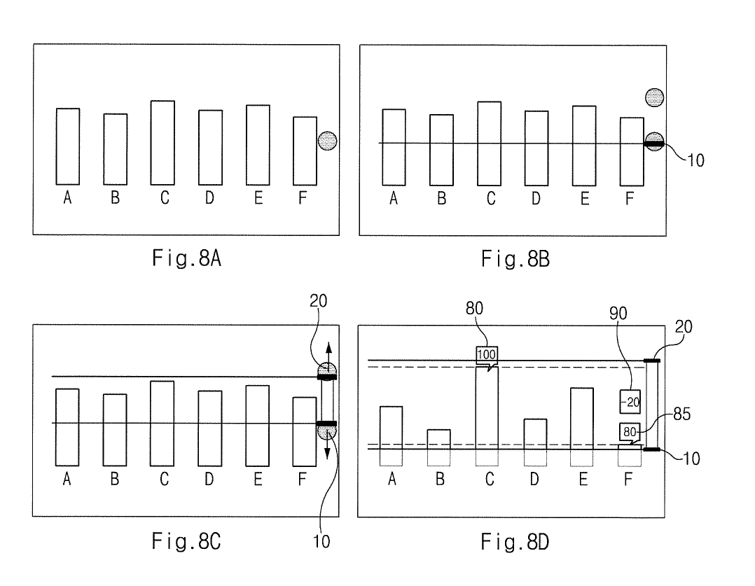

FIGS. 8A to 8D illustrate a process of displaying data according to another embodiment of the present disclosure.

Referring to FIG. 8A, data is displayed as bar graphs on a display screen. Pieces of data shown in FIG. 8A have similar data values, so it is not easy to distinguish them from one another. Make the differences between data clear, data may be expanded or reduced in the y-axis direction.

When a user touches a specific point on the display screen with his or her finger in order to select a first area including at least one of pieces of data displayed on the display screen, the first object 10 may be displayed as shown in FIG. 8B. Then, when the user touches another point by dragging a touched finger or with another finger, the second object 20 may be displayed as shown in FIG. 8C. Then, the user may move the objects until removing the touched fingers from the display screen.

When a user manipulation for selecting the first area is completed, an area specified by objects may be selected as the first area. Referring to FIG. 8C, the area between the first object 10 and the second object 20 may be selected as the first area.

After the first area is selected, the user may touch and move at least one of the first object 10 and the second object 20 in order to select a second area in which the first area is displayed. When a user manipulation for selecting the second area is completed, an area specified by a moved object may be selected as the second area.

When the second area is selected, the first area may be expanded and displayed in the second area. When the first area is expanded and displayed in the second area, it is possible to change the first area according to the maximum value and minimum value of data included in the first area. For example, when the maximum value of data included in the first area is 100 and the minimum value thereof is 80, it is possible to change the first area to an area having data values from 78 to 102 and display a new area in the second area. Thus, as shown in FIG. 8D, it is possible to more clearly display the difference between data included in the first area. Referring to FIG. 8D, the maximum value 80 and minimum value 85 of data included in the first area, and the difference value 90 between the maximum value and the minimum value may be displayed.

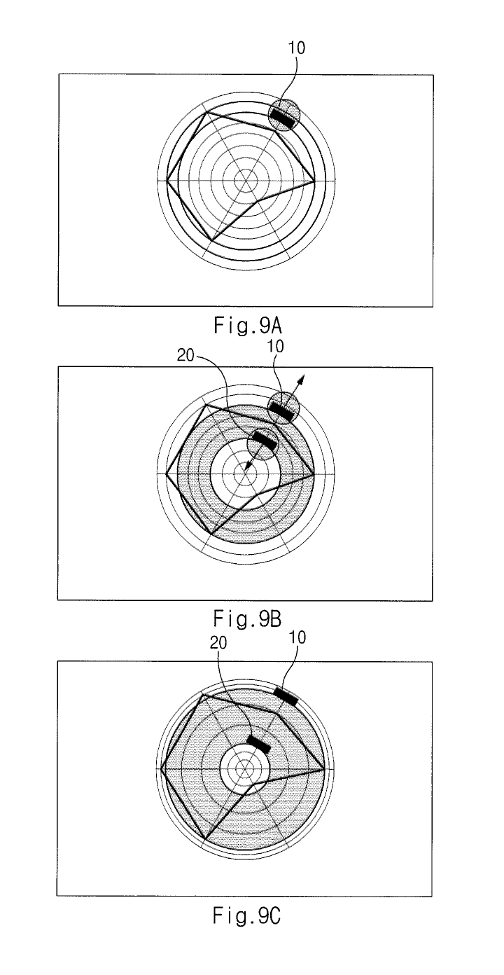

FIGS. 9A to 9C illustrate a process of displaying data according to another embodiment of the present disclosure.

Referring to FIG. 9A, data is displayed as radar charts on a display screen. When a user manipulation for selecting a first area including at least one of pieces of data displayed on the display screen is input, the first object 10 and the second object 20 may be displayed as shown in FIG. 9B. When a user manipulation for selecting the first area is completed, a first area specified by objects may be selected. Referring to FIG. 9B, the area between two circles specified by the first object 10 and the second object 20 may be selected as the first area.

When the first area is selected, the user may touch and move at least one of the first object 10 and the second object 20 in order to select a second area in which the first area is displayed. When a user manipulation for selecting the second area is completed, an area specified by a moved object may be selected as the second area. Referring to FIG. 9C, the area between two circles specified by the first object 10 and the second object 20 may be selected as the second area. When the second area is selected, the first area may be expanded and displayed in the second area as shown in FIG. 9C. Also, areas other than the first area may be reduced and displayed in areas other than the second area.

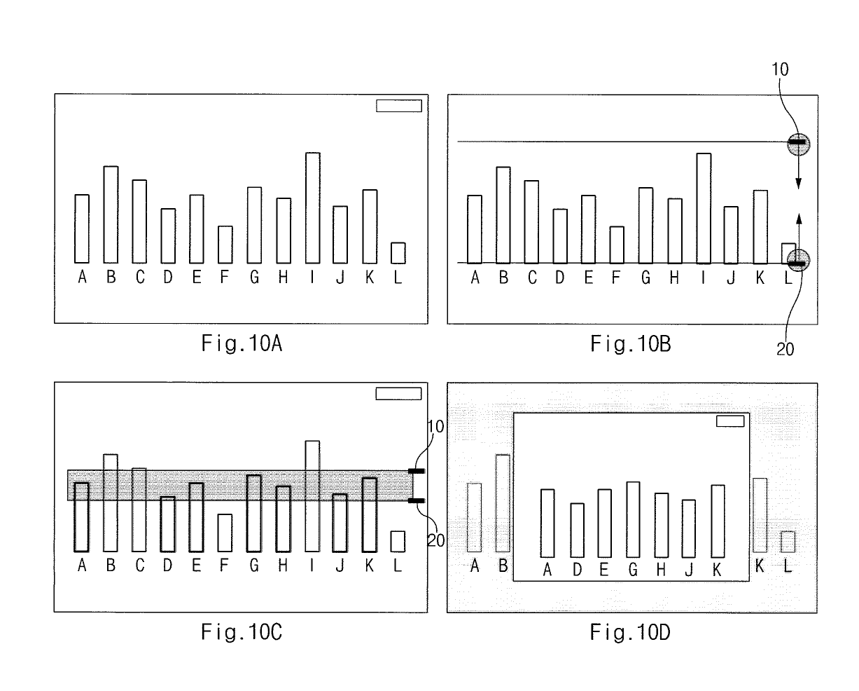

FIGS. 10A to 10D illustrate a process of displaying data according to another embodiment of the present disclosure.

Referring to FIG. 10A, data is displayed as bar graphs on a display screen. When a user manipulation for selecting a first area including at least one of pieces of data displayed on the display screen is input, the first object 10 and the second object 20 may be displayed as shown in FIG. 10B. The user may move the first object 10 and the second object 20, and when a user manipulation for selecting the first area is completed, data included in the first area specified by objects may be selected. Referring to FIG. 10C, the area between the first object 10 and the second object 20 may be selected as the first area.

When the first area is selected, data included in the first area may be selected and displayed in a preset area. For example, as shown in FIG. 10D, it is possible to display, only data having data values included in the first area, in the preset area. In this case, information including the data value, average value, maximum value, minimum value and median of each of selected data may be displayed together.

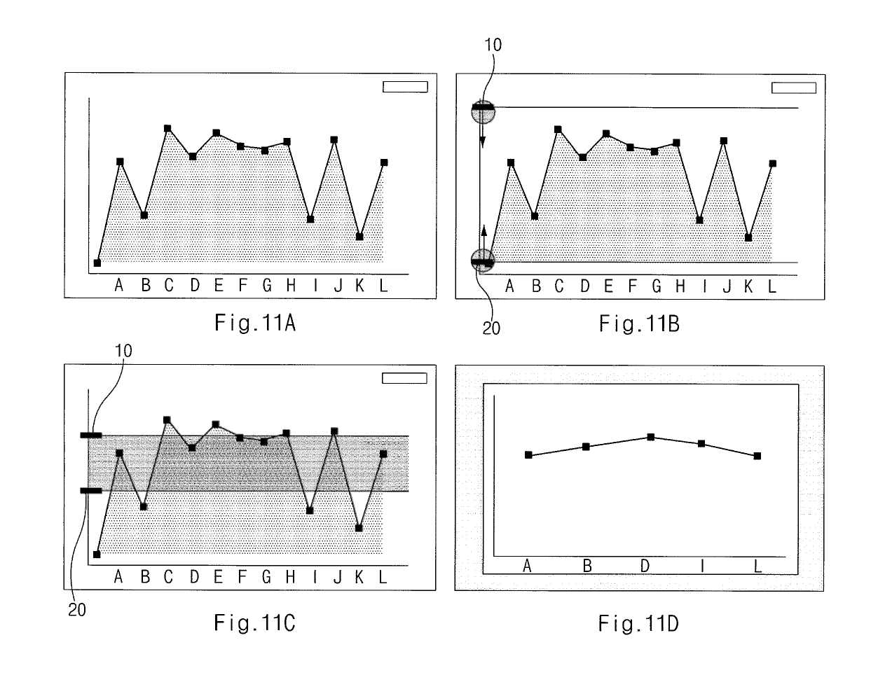

FIGS. 11A to 11D illustrate a process of displaying data according to another embodiment of the present disclosure.

Referring to FIG. 11A, data is displayed as line graphs on a display screen. When a user manipulation for selecting at least one of pieces of data displayed on the display screen is input, the first object 10 and the second object 20 may be displayed as shown in FIG. 11B. The user may move the first object 10 and the second object 20, and when a user manipulation for selecting the first area is completed, data specified by objects may be selected. Referring to FIG. 11C, data included in the area between the first object 10 and the second object 20 may be selected.

Selected data may be displayed in a preset area. For example, as shown in FIG. 11D, it is possible to display, only data having data values included in the first area, in the preset area. In this case, information including the data value, average value, maximum value, minimum value and median of each of selected data may be displayed together.

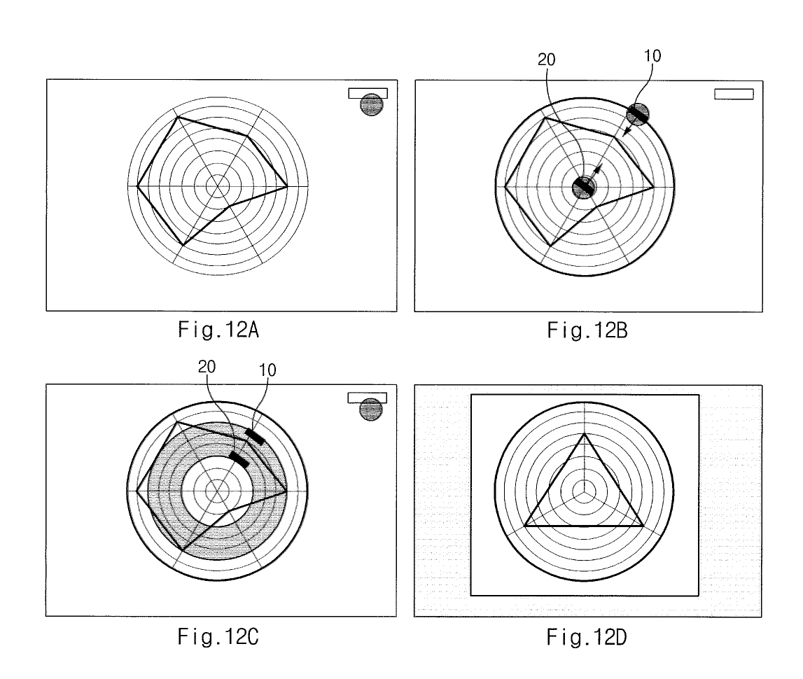

FIGS. 12A to 12D illustrate a process of displaying data according to another embodiment of the present disclosure.

Referring to FIG. 12A, data is displayed as radar charts on a display screen. When a user manipulation for selecting at least one of pieces of data displayed on the display screen is input, the first object 10 and the second object 20 may be displayed as shown in FIG. 12B. The user may move the first object 10 and the second object 20, and when a user manipulation for selecting the first area is completed, data specified by objects may be selected. Referring to FIG. 12C, data included in the area between two circles specified by the first object 10 and the second object 20 may be selected.

Selected data may be displayed in a preset area. For example, as shown in FIG. 12D, when the number of data having data values included in the first are is three, it is possible to display three data as a radar chart in the preset area. In this case, information including the data value, average value, maximum value, minimum value and median of each of selected data may be displayed together.

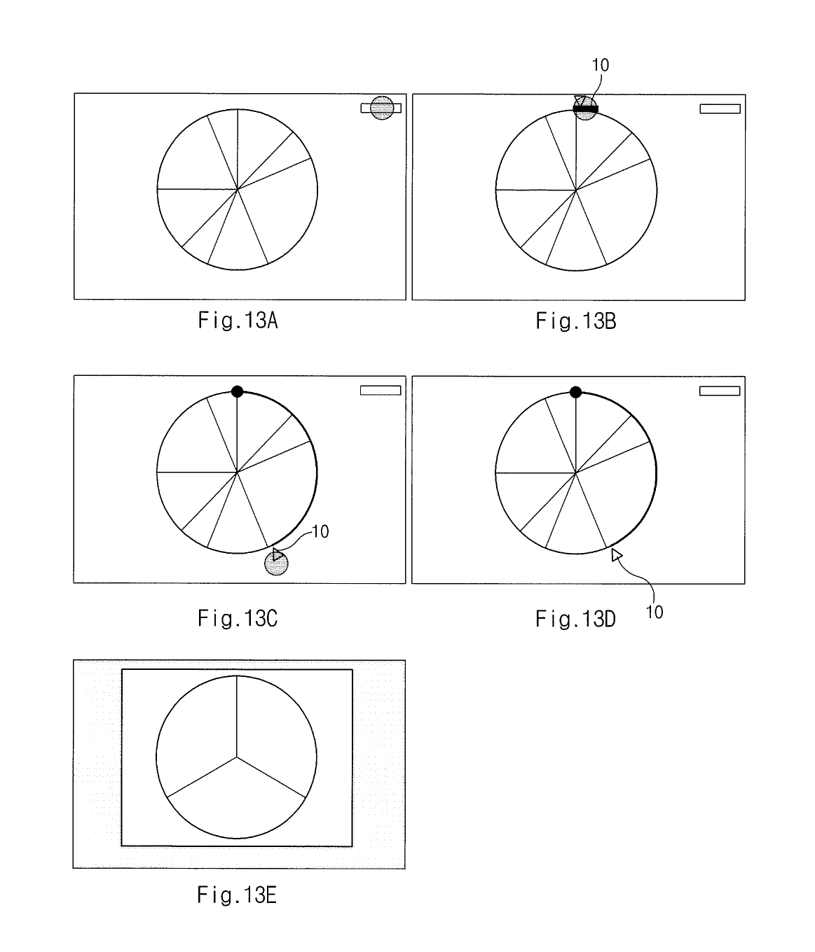

FIGS. 13A to 13E illustrate a process of displaying data according to another embodiment of the present disclosure.

Referring to FIG. 13A, data is displayed as a circle graph on a display screen. When a user manipulation for selecting at least one of pieces of data displayed on the display screen is input, the first object 10 may be displayed as shown in FIG. 13B. Referring to FIG. 13C, a user may move the first object 10 along the circumference, and when the movement of the object is completed, data including the circumference on which a moved first object is placed may be selected and displayed in a preset area as shown in FIG. 13D. For example, as shown in FIG. 13E, when the number of data including the circumference on which a moved first object is placed is three, it is possible to display three data as a circle graph in the preset area. In this case, information including the data value, average value, maximum value, minimum value and median of each of selected data may be displayed together.

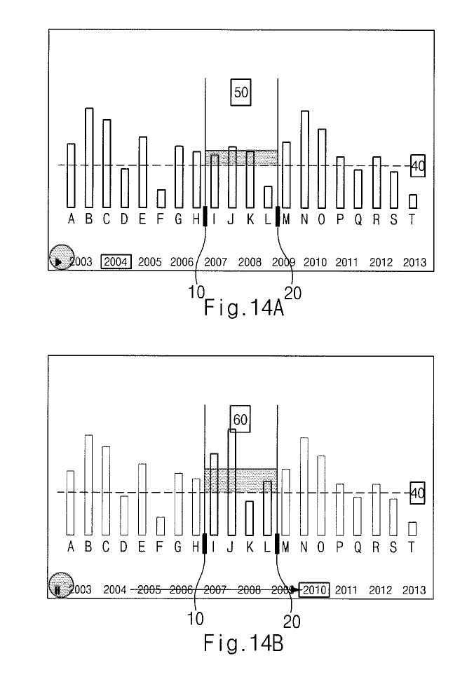

FIGS. 14A and 14B illustrate a process of displaying data according to another embodiment of the present disclosure.

Referring to FIG. 14A, data is displayed as bar graphs on a display screen. When a user manipulation for selecting at least one of pieces of data displayed on the display screen is input, the first object 10 and the second object 20 may be displayed as shown in FIG. 14B. The user may move the first object 10 and the second object 20, and when the movement of the objects is completed, data specified by objects may be selected as a first area. Referring to FIG. 14B, the area between the first object 14 and the second object 20 may be selected as the first area.

As shown in FIG. 14B, data included in the first area may be clearly displayed and remaining data may be vaguely displayed. In addition, information including the data value, average value, maximum value, minimum value and median of each of data included in the first area may be displayed together.

In addition, when a user manipulation for changing data is input while data included in the first area is displayed, data included in the first area may be changed to preset data and then the preset data may be displayed. For example, when there is annual data corresponding to data included in the first area, the annual data corresponding to data included in the first area may be sequentially displayed.

The method of displaying data described with reference to FIGS. 14A and 14B may also be applied to when the first area is expanded and displayed on the second area.

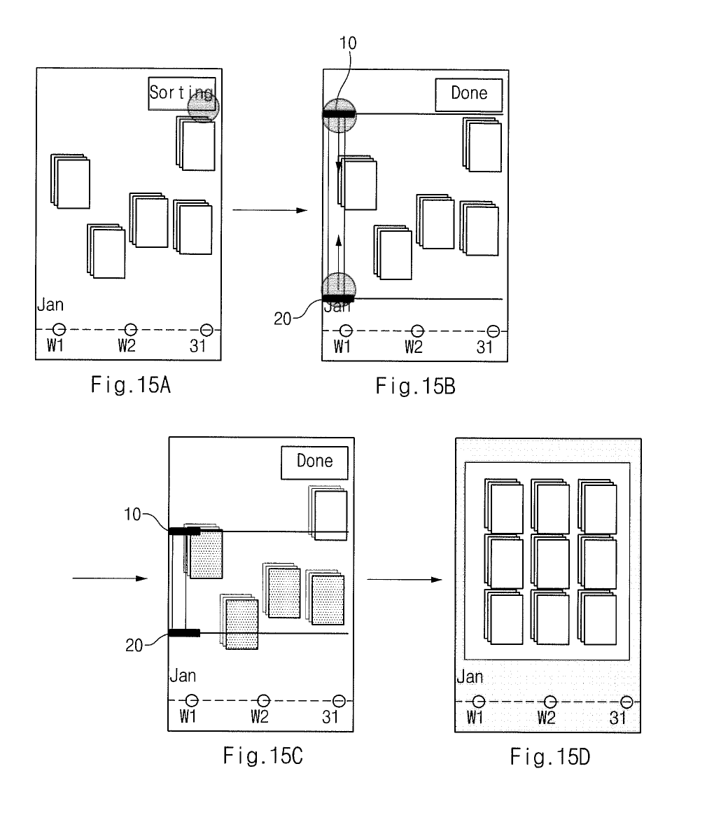

FIGS. 15A to 15D illustrate a process of displaying data according to another embodiment of the present disclosure.

Referring to FIG. 15A, data each of which includes plurality of pieces of detailed data is displayed on a display screen. When a user manipulation for selecting at least one of pieces of data displayed on the display screen is input, the first object 10 and the second object 20 may be displayed as shown in FIG. 15B. The user may move the first object 10 and the second object 20, and when the movement of the objects is completed, an area specified by objects may be selected as a first area. Referring to FIG. 15C, the area between the first object 14 and the second object 20 may be selected as the first area.

When the first area is selected, data included in the first area may be displayed in a preset area. In this case, the detailed data of selected data may be re-aligned and then displayed according to a new criterion as shown in FIG. 15D.

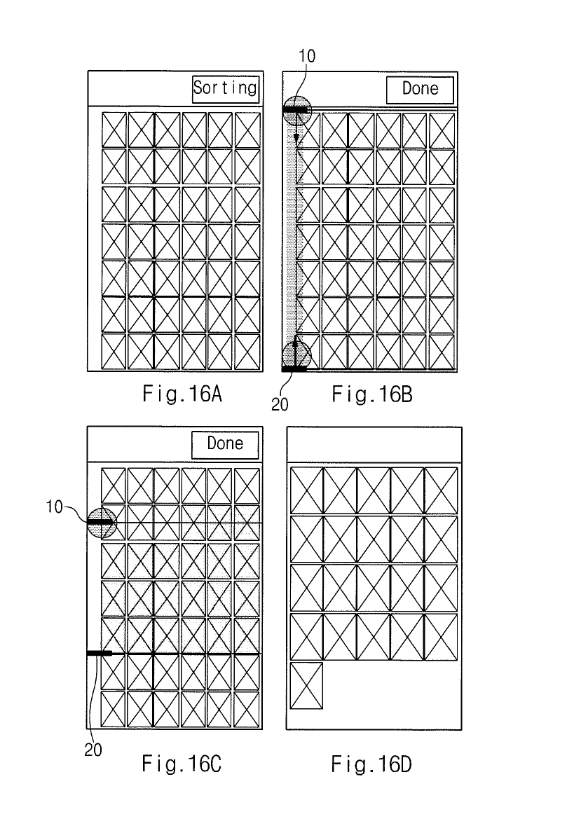

FIGS. 16A-16D illustrates a process of displaying data according to another embodiment of the present disclosure.

Referring to FIG. 16A, pieces of data are aligned and then displayed on a display screen. Unlike the above-described embodiments, data displayed in FIG. 16A may be data such as image data that is simply aligned according to a preset criterion without having certain data values.

When a user manipulation for selecting at least one of pieces of data displayed on the display screen is input, the first object 10 and the second object 20 may be displayed as shown in FIG. 16B. The user may move the first object 10 and the second object 20, and when the movement of the objects is completed, data included in an area specified by objects may be selected.

As shown in FIG. 16C, there may be a case where the area specified by objects includes only a portion of data according to the locations of the objects. In this case, only a portion of unclear data may be selected according to the locations of the objects.

As shown in FIG. 16C, when the first object 10 is placed on the intermediate point of a line identifying data, the half of the unclear data may be selected. If the first object is placed on two thirds point of the upper part, four sheets of data that are the two thirds of the unclear data may be selected. As shown in FIG. 16D, selected data may be aligned and displayed on a new display screen.

Although it is described in the above-described embodiment that the first area is expanded only in one direction and then displayed on the second area, the first area may be expanded in two directions at one time and then displayed on the second area. Also, even if an image or a document is displayed on a display screen, it is possible to expand and then display a specific part of the image or document but to reduce and then display remaining parts.

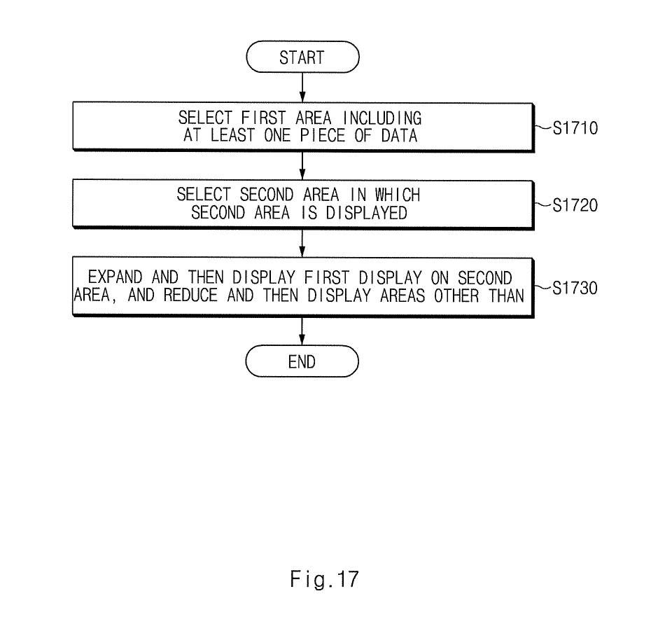

FIG. 17 illustrates a flowchart of a method of displaying data according to an embodiment of the present disclosure.

The descriptions provided with reference to any of FIGS. 2A to 16D may also be equally applied to a method of displaying data according to an embodiment of the present disclosure. Referring to FIG. 17, the electronic device 100 selects a first area including at least one piece of data according to a user manipulation in step S1710. In particular, it is possible to display at least one object on a display screen according to a user manipulation and select an area specified by objects as a first area.

When the first area is selected, a second area in which the first area is displayed is selected according to a user manipulation in step S1720. In particular, it is possible to move objects according to a user manipulation and select an area specified by moved objects as a second area.

Then, the first area is expanded and displayed on the second area and areas other than the first area is reduced and displayed on areas other than the second area in step S1730. In this example, in order to distinguish the second area from areas other than the second area, it is possible to display at least one of the hue, brightness and saturation of the second area differently from that of areas other than the second area. In addition, it is possible to display at least one of the average value, maximum value, minimum value and median of data included in the second area, and the difference value between the maximum value and the minimum value. Also, it is possible to display the data value of data included in the second area. Since related descriptions are provided with reference to FIG. 2, detailed descriptions are left out.

While the first area is expanded and displayed on the second area, objects may move according to a user manipulation. When the first area is added by the movement of the objects, it is possible to expand and then display an added first area on an area specified by the movement of the objects. Also, when at least a portion of the first area is excluded by the movement of the objects, it is possible to reduce and then display an excluded first area on areas other than the area specified by the movement of the objects. Since related descriptions are provided with reference to FIGS. 4a to 6f, detailed descriptions are left out.

In addition, while the first area is expanded and displayed, it is possible to change and then display data included in the first area to preset data. Since related descriptions are provided with reference to FIGS. 14A-14B, detailed descriptions are left out.

The method of displaying data according to various embodiments of the present disclosure as described above may be implemented in programs that may be executed on an electronic device. In addition, these programs may be stored and used in various types of recording mediums.

In particular, program codes for performing the above-described methods may be stored in various types of non-volatile recording mediums such as a flash memory, a ROM, an EPROM, an EEPROM, a hard disk, a removable disk, a memory card, an USB memory, and a CD-ROM.

According to various embodiments of the present disclosure as described above, a user may expand a portion of data without disturbing other data, and it is possible to efficiently provide information to the user by displaying particular information on expanded data.

Also, the user may select data conveniently and intuitively and be provided selected data by using various methods.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
at least one input configured to receive a user input;
a controller configured to select a first area including at least one datum according to a user manipulation and select a second area in which the first area is displayed; and
a display configured to expand and then display the first area on the second area, wherein the display is further configured to reduce and then display another area than the first area on areas other than the second area.

2. The electronic device according to claim 1, wherein:
the display is configured to display at least one object when a user manipulation for selecting the first area is input, and
the controller selects an area specified by the at least one object as the first area.

3. The electronic device according to claim 2, wherein when the first area is selected and then the at least one object moves according to a user manipulation, the controller is configured to select an area specified by the moved object as the second area.

4. The electronic device according to claim 3, wherein when the at least one object moves according to a user manipulation while the first area is expanded and then displayed, the controller is configured to use the moved object to change the first area and the second area.

5. The electronic device according to claim 1, wherein the display is configured to display at least one of a hue, a brightness, or a saturation of the second area differently from that of areas other than the second area.

6. The electronic device according to claim 1, wherein the display is configured to display at least one of an average value, a maximum value, a minimum value, or a median of data, and a difference value between the maximum value and the minimum value on the second area, wherein the data is included in the first area.

7. The electronic device according to claim 1, wherein the display is configured to display data values of data included in the first area in the second area.

8. The electronic device according to claim 1, wherein when data included in the first area includes detailed data corresponding to a lower category, the display is configured to display the detailed data on the second area.

9. A method of displaying data, the method comprising:
selecting a first area including at least one datum according to a user manipulation;
selecting a second area in which the first area is displayed, according to a user manipulation; and
expanding and then displaying the first area on the second area and reducing and then displaying another area than the first area on areas other than the second area.

10. The method according to claim 9, wherein selecting the first area comprises:
displaying at least one object on the display screen according to a user manipulation; and
selecting an area specified by the at least one object as the first area.

11. The method according to claim 10, wherein selecting the second area comprises:
moving the at least one object according to a user manipulation; and
selecting an area specified by the moved object as the first area.

12. The method according to claim 11, further comprising:
moving the at least one object according to a user manipulation while the first area is expanded and then displayed; and
expanding and then displaying an added first area on an area specified by movement of the at least one object when the first area is added by the movement of the object.

13. The method according to claim 11, further comprising:
moving the at least one object according to a user manipulation while the first area is expanded and then displayed; and
reducing and then displaying an excluded first area on areas other than the area specified by the movement of the at least one object when at least a portion of the first area is excluded by the movement of the at least one object.

14. The method according to claim 9, further comprising changing and then displaying data included in the first area to preset data, while the first area is expanded and then displayed.

15. A non-transitory computer readable medium comprising program code for:
selecting a first area including at least one datum according to a user manipulation;
selecting a second area in which the first area is displayed, according to a user manipulation; and
expanding and then displaying the first area on the second area and reducing and then displaying another area than the first area on areas other than the second area.

16. The computer readable medium according to claim 15, wherein the program code for selecting the first area comprises program code for:
displaying at least one object on the display screen according to a user manipulation; and
selecting an area specified by the at least one object as the first area.

17. The computer readable medium according to claim 16, wherein the program code for selecting the second area comprises program code for:
moving the at least one object according to a user manipulation; and
selecting an area specified by the moved object as the first area.

18. The computer readable medium according to claim 17, further comprising program code for:
moving the at least one object according to a user manipulation while the first area is expanded and then displayed; and
expanding and then displaying an added first area on an area specified by movement of the at least one object when the first area is added by the movement of the object.

19. The computer readable medium according to claim 17, further comprising program code for:
moving the at least one object according to a user manipulation while the first area is expanded and then displayed; and
reducing and then displaying an excluded first area on areas other than the area specified by the movement of the at least one object when at least a portion of the first area is excluded by the movement of the at least one object.

20. The computer readable medium according to claim 15, further comprising program code for changing and then displaying data included in the first area to preset data, while the first area is expanded and then displayed.
